(19) United States
(12) Patent Application Publication
(10) Pub. No.: US 2016/0363765 A1
(43) Pub. Date: Dec. 15, 2016

(54) APPARATUS AND METHOD FOR CONTROLLING THE INTENSITY OF AN IMAGE GENERATED BY A HEAD- UP DISPLAY DEVICE

(71) Applicant: FORD GLOBAL TECHNOLOGIES, LLC, Dearborn, MI (US)

(72) Inventors: Marcus HAEFNER, Koeln (DE); Matus BANYAY, Frechen (DE)

(21) Appl. No.: 15/178,013

(22) Filed: Jun. 9, 2016

(30) Foreign Application Priority Data
Jun. 12, 2015 (DE) 10 2015 210 774.4

(51) Int. Cl. G02B 27/01; G03B 21/14; G02B 27/28; G03B 21/20

(52) U.S. Cl. CPC G02B 27/0101; G03B 21/2053; G03B 21/2073; G03B 21/145; G02B 27/281; G02B 2027/0118

(57) ABSTRACT

A head-up display (HUD) device for a motor vehicle has a projector generating a polarized light signal directed at a display surface (such as a windshield or separate combiner plate) for viewing by a driver of the vehicle. A light sensor is disposed adjacent to the projector to detect and measure the intensity of ambient light entering the vehicle and control the intensity of the light generated by the projector in dependence on the measured ambient light intensity. The light sensor is fitted with a polarization filter that is cross-polarized relative to the polarization of the light generated by the projector so that the intensity of the ambient light reaching the sensor is independent of the intensity of the light emitted by the projector.

### CROSS-REFERENCE TO RELATED APPLICATIONS

This application claims foreign priority benefits under 35 U.S.C. §119(a)-(d) to DE 10 2015 210 774.4 filed Jun. 12, 2015, which is hereby incorporated by reference in its entirety.

### TECHNICAL FIELD

The present invention relates to a head-up display device of the type used in motor vehicle, and to a method and apparatus for controlling the intensity of light emitted by a projector of such head-up display.

### BACKGROUND

Head-up display (HUD) devices have the task of projecting or displaying information in or into the viewing region of a driver of a vehicle, in particular a motor vehicle. To this end, usually at least a projector and a display surface are provided. The projector generates the information to be displayed as an image and represents it by way of light that is displayed by the display surface in the viewing region of the driver. The display surface is a light-transmissive and reflective surface, such as for example a windshield of the motor vehicle or a combiner inside the vehicle and spaced from the windshield. The light emitted by the projector is projected onto the inner side of the windshield or a separate combiner disposed between the windshield and driver such that the driver can see or perceive both the projected virtual image and the real world behind the windshield at the same time. The images appear to the driver such as if they were freely floating outside the windshield.

Combiner HUD devides are those at display a virtual image using a separate pane of transparent material in the viewing region of the driver of the vehicle. As a result, a combiner head-up display can be used independently of the windshield form and thus for different vehicle types.

For good perceivability or readability of the virtual image in the viewing region of the driver, a particular contrast ratio between the light projected onto the display surface and the currently prevailing ambient light in the viewing region of the driver is necessary.

Against this background, the present invention is based on the object of creating a head-up projection device and a method for projecting a virtual image into a viewing region of a driver of a vehicle, which projection device ensures good perceivability or readability of the virtual image on the part of the driver of the vehicle at all times, that is to say in particular at varying ambient light conditions. In addition, the complexity of installing the HUD device into the vehicle should be as low as possible and the HUD device should be compact.

### SUMMARY

In a disclosed embodiment, a HUD device for projecting a virtual image into a viewing region of a driver of a vehicle, in particular a motor vehicle, comprises a projector for emitting light representing the virtual image, a display surface for displaying the light in the viewing region, and at least one light sensor for capturing an intensity of the ambient light prevailing in the viewing region of the driver, so as to adapt the intensity of the emitted light in dependence on the captured intensity of the ambient light. This ensures good perceivability or readability of the virtual image on the part of the driver of the vehicle.

A HUD device refers to a device or unit which can project an item of image information into the viewing region of the driver, for example in front of the driver of the vehicle, through a front pane or windshield of the vehicle. The vehicle can be a motor vehicle, for example a passenger car, a truck, a motor bicycle or an airplane. The viewing region within the context of the present disclosure is to be understood to mean in particular the region in front of the driver as viewed in the viewing direction of the driver. The viewing region can be arranged for example in the direction of a windshield of the vehicle. The virtual image can be a representation that is located in the viewing region from the view of the driver. For example, the virtual image can be represented from the view of the driver as if it were apparently floating in front of the windshield, or can be displayed in an area surrounding the vehicle located in the viewing region. The virtual image can represent for example an alphanumeric character or symbol. Additionally or alternatively, the virtual image can also be projected into a viewing region of another occupant of the vehicle, for example a front passenger.

The projector is understood to mean a device which generates light to form an image, in particular a thin-film transistor (TFT) display. The projector can have a plurality of light sources for generating individual image points of the virtual image. The light can thus be a bundle of a plurality of light beams. The individual light beams can have different wavelengths so as to be able to represent the virtual image in different colors. The display surface (commonly referred to as a combiner when separate from the windshield) and the projector may be arranged such that the light emitted by the projector strikes the display surface and is reflected into the viewing region. The display surface can be a pane or plate. The display surface can be designed to be reflective with respect to the light signal. Furthermore, the display surface can be configured to be light-transmissive with respect to light that strikes the display surface from a side of the display surface that is remote from the driver. In this way, the viewing region of the driver will not be limited, or limited only slightly, by the display surface, and the virtual image can still be projected into the viewing region. The light sensor can be a photodiode or a camera. Ambient light within the meaning of the present invention is understood to mean light that enters the vehicle from the space surrounding it. In particular, according to the invention the ambient light that is perceived by the driver in his viewing region is captured by the light sensor.

The intensity of the ambient light is preferably continuously detected and measured such that the intensity of the emitted light (emitted by the projector) can preferably be constantly adapted to the current intensity of the ambient light in the viewing region of the driver. Here, the intensity of the emitted light signal is preferably increased as the intensity of the ambient light in the viewing region of the driver increases, otherwise it can be decreased.

According to a disclosed embodiment, the light signal emitted by the projector has a predetermined polarization property. The invention utilizes the property of projectors, for example a TFT display, of sending out the light signal having a polarization. The ambient light, on the other hand, is not polarized. Furthermore, a polarization filter is arranged in the beam path of the ambient light to the light sensor, which polarization filter filters the ambient light striking the light sensor such that the polarization property of the light signal emitted by the projector is filtered out. In other words, the polarization filter is cross-polarized relative to the light signal and so filters the polarized light signal emitted by the projector out of the ambient light before it strikes the light sensor. This ensures that the intensity of the incident light captured by the light sensor is dependent only on the ambient light in the viewing region of the driver, and includes no portion of the light signal emitted by the projector.

One advantageous disclosed embodiment provides for at least one optical element for guiding the light signal emitted by the projector to be arranged, with respect to the beam path of the light signal emitted by the projector, downstream of the projector and upstream of the display surface. An optical element can be, for example, a reflective element such as a mirror, concave mirror and the like, or a refractive element such as a lens, a converging lens and the like, or a semi-transmissive element such as a semi-transmissive mirror, prism and the like, or a dielectric or dichroic element such as a wavelength-filtering mirror and the like, and also a combination thereof. One or more of these optical elements can be arranged in the beam path between the projector and the display surface.

According to one further advantageous embodiment, the HUD device has a housing in which the projector, the light sensor, the polarization filter, and the at least one optical element are housed. In this manner it is possible to significantly reduce in particular the installation complexity for the projection device, since no additional components that are separate from the housing of the projection device need to be installed. In addition, the projection device can thus be configured to be compact since all the essential components are arranged within the housing.

A yet further advantageous embodiment provides for the light sensor to be arranged such that the ambient light strikes the at least one optical element before it strikes the light sensor. In other words, the same optical element is used both to direct the light signal emitted by the projector onto the display surface and to direct the ambient light onto the light sensor. Therefore, no additional optical element is necessary for guiding the ambient light to the light sensor, which further simplifies the construction and the manufacturing costs of the projection device.

According to a further disclosed embodiment, a method for projecting a virtual image into a viewing region of a driver of a vehicle is provided, which method comprises emitting a light signal having a prespecifiable intensity for representing the virtual image, displaying the light signal in the viewing region using a display surface, detecting an intensity of the ambient light prevailing in the viewing region of the driver using at least one light sensor, and adapting the intensity of the emitted light signal in dependence on the intensity of the captured ambient light. With respect to the meaning of the previously mentioned terms, reference is made to the earlier explanations relating to the projection device according to the invention, which should analogously also apply to the method according to the invention.

The method according to the invention furthermore provides for modulating the emitted light signal such that it has a predetermined polarization property. This modulation of the light signal emitted by the projector may be carried out by the projector itself, in particular for example by a thin-film transistor (TFT) display. The method furthermore comprises filtering the predetermined polarization property of the emitted light signal out of the ambient light striking the light sensor before it strikes the light sensor using a polarization filter.

According to one advantageous embodiment of the method, the emitted light signal is guided to the display surface using at least one optical element, and the ambient light is guided to the light sensor using the same optical element.

The steps of the method can be implemented by elements and devices of a projection device as described above. Necessary control signals for driving corresponding elements or devices can be made available by a suitable control device, for example in the form of an electric circuit.

Further features and advantages of the invention can be gathered from the following description of an exemplary embodiment of the invention that is to be understood to be non-limiting and will be described in more detail below with reference to the drawing. In this drawing, the figures schematically show:

### BRIEF DESCRIPTION OF THE DRAWINGS

FIG. 1 a sectional side view of a vehicle having a projection device according to an exemplary embodiment of the present invention and an enlarged detail view thereof,

FIG. 2 is a detail view of the portion of FIG. 1 surrounded by box B, and

FIG. 3 a block diagram of the projection device from FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the various figures, parts that are equivalent in terms of their function always have the same reference sign and are thus generally also described only once.

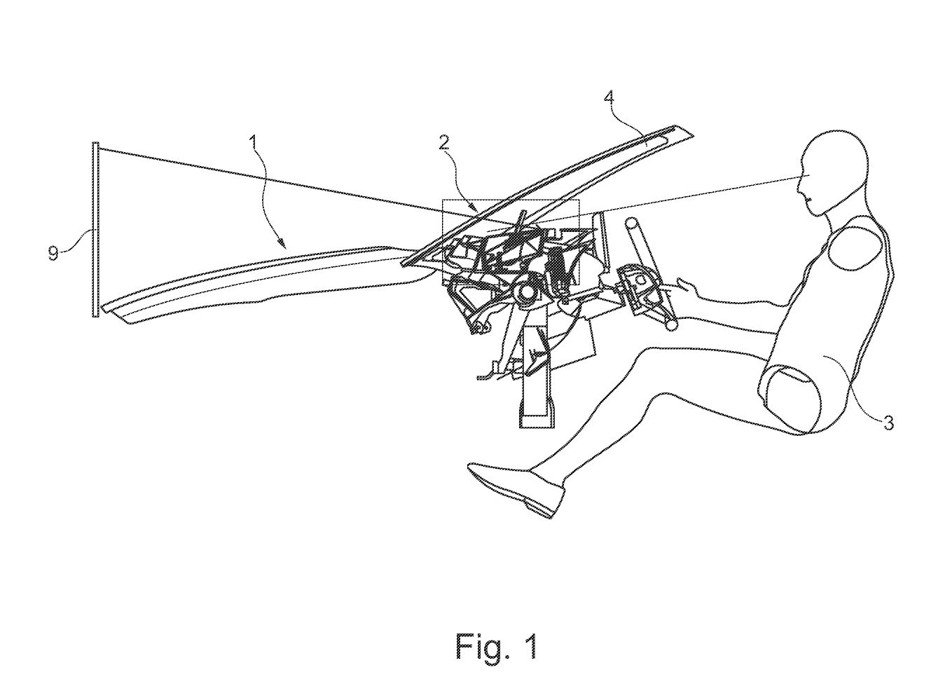

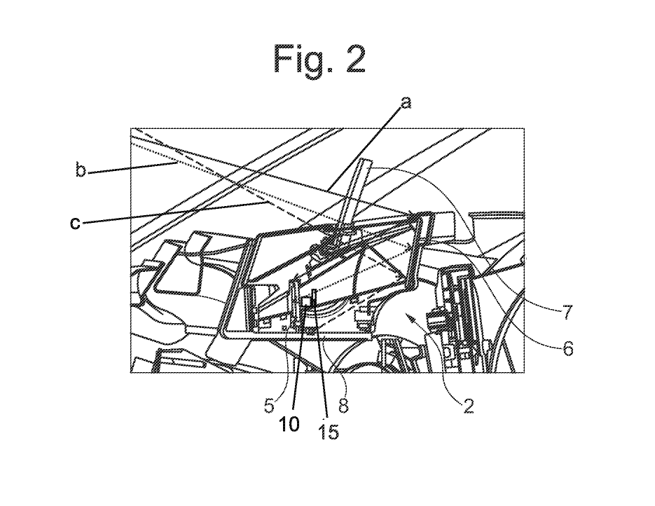

FIG. 1 illustrates a sectional side view of a vehicle 1 having a head-up display (HUD) device 2 for projecting a virtual image into a viewing region of a driver 3 of the vehicle 1 according to one exemplary embodiment of the present invention, and FIG. 2 is an enlarged detail view of the HUD device 2.

The HUD device 2 in the exemplary embodiment illustrated in FIGS. 1 and 2 is configured as a combiner head-up display which is arranged adjacent to a windshield 4 of the vehicle 1. During operation of the HUD device 2, a virtual image is displayed in the viewing region of the driver 3 of the vehicle 1.

The HUD device 2 includes a projector 5, in this case a TFT display, which generates and emits light to form symbols representing the virtual image. The light is directed, via a reflective optical element 6, here in the form of a mirror, for example a concave mirror or flat mirror or freeform mirror, onto a display surface 7 so as to display the light in the viewing region of the driver 3. The display surface 7 in the illustrated exemplary embodiment represents the combiner of the combiner HUD display 2.

According to this exemplary embodiment, the projector 5 and the optical element 6 are arranged in a housing 8 that is integrated in a dashboard of the vehicle 1. The housing 8 has, toward the surface of the dashboard, a through opening through which the light that is reflected by the optical element 6 can exit the housing 8 and strike the display surface 7. The display surface 7 is configured as a plate or pane, here a curved pane, for example spherical, aspherical or freeform. The display surface 7 is arranged outside the housing 8 and extends starting from a surface of the dashboard away from the surface of the dashboard. At least one region of the display surface 7 that is remote from the surface of the dashboard is located in the viewing region of the driver 3. The display surface 7 can be configured for example to be rectangular or semi-circular. The display surface 7 is configured to display or present an image represented by the light signal emitted by the projector in the viewing region of the driver 3. The display surface 7 is of light-transmissive design such that the driver 3 can view the environment of the vehicle through the display surface 7.

According to the exemplary embodiment illustrated in FIG. 1, the HUD device 2 furthermore comprises a light sensor 10 for detecting an intensity of the ambient light prevailing in the viewing region of the driver. As is well known in the art, the light sensor 10 is operatively connected with the projector 5 so that the intensity of the light emitted by the projector is adapted in dependence on the intensity of the ambient light as detected by the light sensor. The light sensor 10 preferably receives ambient light entering the vehicle from a region 9 in front of the windshield 4 of the vehicle 1 that is marked in FIG. 1 by a thick bar. Furthermore, different possible beam paths a, b, and c of the ambient light incident upon the optical element 6 and reflecting therefrom toward the projector 5 are illustrated in FIG. 2 by way of corresponding arrows (solid, dotted, and dashed, respectively). It may be seen that the ambient light (as exemplified by rays a, b, c) passes through the light-transmissive display surface 7, strikes the optical element 6, and is reflected thereby in the direction of the projector 5 within the housing 8. The light sensor 10 is preferably arranged at the end of the corresponding arrows, that is to say for example above, below or next to the projector 5 in the housing 8, depending on which beam path of the ambient light reaching the HUD device 2 should be captured and evaluated.

It is also possible for the HUD device 2 to have more than one light sensor, preferably within the housing 8, such that the light intensity of different beam paths can be detected by the corresponding light sensors, from which for example an average can be calculated for determining the intensity of the ambient light prevailing in the viewing region of the driver 3.

The HUD device 2 illustrated in FIGS. 1 and 2 furthermore has a polarization filter 15 that is associated with the light sensor 10. The polarization filter is preferably likewise housed in the housing 8 and arranged for example in the immediate vicinity of the light sensor 10 so that substantially all light striking the light sensor has passed through the filter. Conventionally, the light emitted by the projector 5 has a polarization property that stems from the mode of operation of the TFT display that acts as the projector 5, as is generally known. By contrast, the ambient light (which enters the vehicle through the windshield and other daylight openings) has no polarization. The polarization filter 15 that is associated with the light sensor is chosen such that it is cross-polarized relative to the polarization of the light emitted by the projector, so that it filters the polarization property of the emitted light out of the ambient light that strikes the light sensor 10. In other words, the polarization filter 15 does not pass (allow through) any portion of the emitted light signal that accompanies the ambient light. The result is that the light intensity detected by the light sensor 10 is dependent only on the ambient light prevailing in the viewing region of the driver 3, regardless of the intensity of the light signal emitted by the projector.

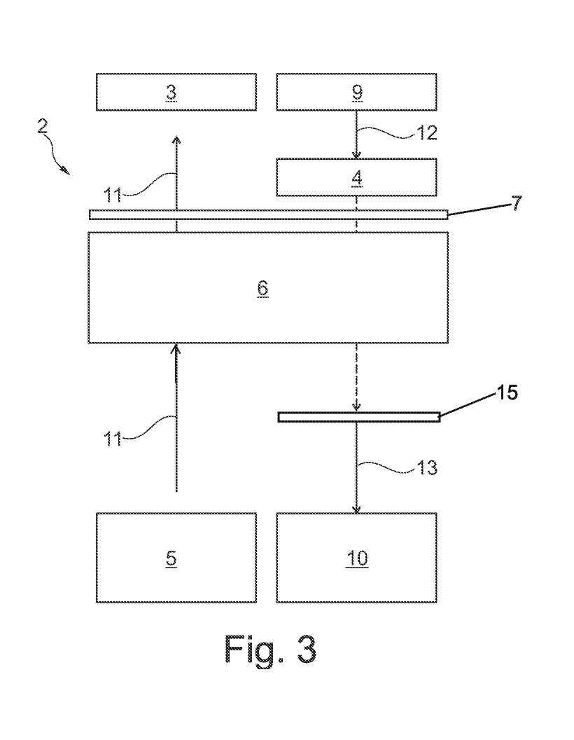

FIG. 3 illustrates a block diagram of the HUD device 2 from FIGS. 1 and 2. Schematically illustrated are the driver 3, the windshield 4, the projector 5, the at least one optical element 6, the region 9 of the captured ambient light, and a light sensor 10.

As can be seen in FIG. 3 in the left-hand half of the image, a polarized light signal 11, for example s-polarized light, is emitted by the projector 5. The projector 5, for example a TFT display, here serves in a known manner as a modulator of the light signal. The s-polarized light signal 11 is subsequently guided by the at least one optical element 6, for example a mirror, to the display surface 7, such that the display surface can display the virtual image of the light signal in the viewing region of the driver 3.

It may be seen in the right-hand side of FIG. 3 that non-polarized ambient light 12 enters the vehicle from the region 9 through the windshield 4 and is reflected toward the light sensor 10 by optical element, the same optical element 6 that guides the s-polarized light signal 11 emitted by the projector 5 to the driver 3. On its way from the windshield 4 to the light sensor 10, the initially non-polarized ambient light 12 is filtered using a polarization filter 15, such that all ambient light passing through the filter likewise has a polarization property. The polarization filter 15 is cross-polarized relative to the polarization property of the s-polarized light signal 11; i.e. it filters out all light having the same polarization property as the light signal. In other words, the polarization filter 15 in the exemplary embodiment illustrated in FIG. 3 of the HUD device 2 filters all s-polarized light 11 out of the non-polarized ambient light 12, such that the light passing through the polarization filter is (in this exemplary case) p-polarized. The now filtered and p-polarized ambient light 13, the intensity of which after filtering is dependent only on the intensity of the ambient light prevailing in the viewing region of the driver 3 and is not influenced by the intensity of the emitted light 11, subsequently strikes the light sensor 10, where the intensity of the ambient light is detected. The intensity of the light signal 11 emitted by the projector is subsequently adapted in dependence on the intensity of the ambient light captured by the light sensor 10 such that good perceivability and readability of the virtual image on the part of the driver 3 is always ensured owing to sufficient contrast.

The HUD device according to the invention and the method were explained in more detail with reference to an exemplary embodiment illustrated in the figures. The HUD device and the method are, however, not limited to the embodiment described here, but also comprise further embodiments with the same function. In particular, the invention can be applied to head-up displays in which the display surface is the windshield or a separate combiner pane/plate in the same way. Furthermore, the polarization property of the emitted light will be dependent on the type of the projector used, such that the polarization filter is selected such that it will be able in any case to filter the emitted polarized light out of the non-polarized ambient light. For example, in the case of a light signal of left-hand polarization, that is circularly polarized by the projector, the ambient light filtered by the polarization filter after it passes through the filter will be right-hand polarized. To this end, the polarization filter can be a lambda/4 filter for filtering circularly polarized light (left-hand or right-hand polarization) or a lambda/2 filter in the case of linearly polarized light (s-polarization or p-polarization).

The HUD device according to the invention is used in a preferred configuration as a windshield head-up display or as a combiner head-up display in a vehicle, in particular a motor vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A head-up display device of a motor vehicle, comprising:
a display surface in a viewing region of a vehicle driver;
a projector emitting light having a first polarization and directing the light onto the display surface to present an image visible to the driver;
a light sensor disposed immediately adjacent to the projector and detecting an intensity of ambient light, the intensity of the ambient light controlling an intensity of the light emitted by the projector; and
a polarization filter cross-polarized relative to the first polarization and disposed immediately adjacent to the light sensor to filter the ambient light detected by the light sensor.

2. The device of claim 1, wherein the display surface is a combiner separate from a vehicle windshield.

3. The device of claim 1, further comprising an optical element located between the projector and the display surface and directing the light onto the display surface.

4. The device of claim 3, wherein the optical element is a mirror.

5. The device of claim 3, wherein the optical element directs the ambient light onto the light sensor.

6. The device of claim 3, further comprising a housing mounted in an instrument panel of the vehicle and in which the projector, the light sensor, the polarization filter, and the optical element are housed.

7. A head-up display device, comprising:
a projector emitting a light signal having a polarization;
a light sensor detecting an intensity of ambient light, and controlling an intensity of the light signal in dependence thereon; and
a polarization filter filtering the ambient light striking the light sensor and being cross-polarized relative to the polarization of the light signal.

8. The device of claim 7, further comprising a display surface onto which the light signal is directed by the projector.

9. The device of claim 8, wherein the display surface is a combiner separate from a vehicle windshield.

10. The device of claim 8, further comprising an optical element located between the projector and the display surface and directing the light signal onto the display surface.

11. The device of claim 10, wherein the optical element is a mirror.

12. The device of claim 10, further comprising a housing in which the projector, the light sensor, the polarization filter, and the optical element are housed.

13. The device of claim 10, wherein the optical element directs the ambient light onto the light sensor.

14. A method for operating a head-up display device of a vehicle, comprising:
operating a projector to generate a polarized light directed at a display surface for viewing by a driver of the vehicle;
filtering ambient light striking a light sensor disposed adjacent to the projector using a polarization filter that is cross-polarized relative to the polarized light generated by the projector; and
controlling an intensity of the polarized light generated by the projector in dependence on the intensity of the filtered ambient light detected by the light sensor.

15. The method of claim 14, further comprising directing the polarized light to the display surface using an optical element.

16. The method of claim 15, further comprising directing the ambient light to the light sensor using the optical element.
